(19) United States
(12) Patent Application Publication
(10) Pub. No.: US 2024/0111594 A1
(43) Pub. Date: Apr. 4, 2024

(54) APPARATUS AND METHODS FOR RADIO ACCESS NETWORK OPTIMIZATION BY EXTENDING NEAR-RT AND NON-RT RIC FUNCTIONALITY FOR O-CLOUD OPTIMIZATION AND MANAGEMENT

(71) Applicant: F5, Inc., Seattle, WA (US)

(72) Inventor: Ravishankar RAVINDRAN, San Ramon, CA (US)

(73) Assignee: F5, Inc., Seattle, WA (US)

(21) Appl. No.: 18/375,145

(22) Filed: Sep. 29, 2023

Related U.S. Application Data
(60) Provisional application No. 63/411,733, filed on Sep. 30, 2022.

(51) Int. Cl. G06F 9/50

(52) U.S. Cl. CPC G06F 9/5044; G06F 9/505

(57) ABSTRACT

Technology related to near-realtime O-Cloud optimization requirements by extending O-Cloud Near-RT and Non-RT functionality. In one example, a method includes receiving, via an interface between the O-Cloud orchestrator and the near-realtime RAN intelligent controller, policies related to O-Cloud workload optimization. It further includes determining, one or more policy scenarios have occurred. Then transmitting, from the near-realtime RAN intelligent controller to the O-Cloud, instructions for one or more corrective actions. The method further includes executing, via one or more XApps on the O-Cloud, one or more corrective actions consistent with the received instructions. Finally, transmitting, from the one or more Xapps on the O-Cloud, confirmation of the execution of the one or more corrective actions.

### RELATED APPLICATIONS

The present application claims priority to U.S. application Ser. No. 18/375,145, filed on Sep. 29, 2023 and U.S. Provisional Application No. 63/411,733 filed on Sep. 30, 2022 and entitled APPARATUS AND METHODS FOR RADIO ACCESS NETWORK OPTIMIZATION BY EXTENDING NEAR-RT AND NON-RT RIC FUNCTIONALITY FOR O-CLOUD OPTIMIZATION AND MANAGEMENT AND DEVICES THEREOF, which is herein incorporated by reference in its entirety.

### TECHNICAL FIELD

Embodiments described herein generally relate to the field of wireless communications systems, and in particular to the management of the Radio Access Network of a wireless communications system. More specifically, embodiments herein are directed to Open RAN (O-RAN) architectures and, more specifically, techniques and methods for non-real time and real-time optimization in O-RAN architectures BACKGROUND

With the increase in different types of devices communicating with various network devices, usage of 3GPP LTE systems has increased. The penetration of mobile devices in modern society has continued to drive demand for a wide variety of networked devices. As mobile traffic increases, mobile networks and the equipment that runs them must become more software-driven, virtualized, flexible, intelligent and energy efficient. 5G networks have increased throughput, coverage, and robustness and reduced latency and operational and capital expenditures through the use of radio access network (RAN) technology.

The virtualization of RAN and move towards more container-based and cloud-native implementations of RANs have led to the development of industry-wide standards for open RAN interfaces. These standards, driven by the O-RAN and 3GPP, support the interoperability of RAN equipment regardless of vendor.

As described further herein, the O-RAN architecture introduces two important control and management functions over the existing LTE/5G RAN architectures proposed by 3GPP First, is the RAN Intelligent Controller (RIC) which decouples the RAN related control plane radio resource management (RRM) and optimization functions from the vendor supplied RAN function over an open interface, this is compared to closed SON optimization functionality offered by vendors today and mostly tied to specific vendor implementations. Second, the Service Management and Orchestration (SMO) functions to manage the FCAPS of RAN and the O-Cloud infrastructure, also over open interfaces.

RIC has two architectural components, the near-RT RIC and the non-RT RIC. The RIC is a platform to host RRM optimization applications applicable to L1/L2/L3 of the RAN stack. Near-RT RIC hosts optimization functions with control loop latencies of 10 ms-1 s. Near-RT RIC is hosted is hosted in the far-edge or the edge cloud deployments to manage the mission critical applications. Non-RT RIC hosts optimization function with control loop latencies of >1 s. The non-RT RIC is centralized and co-located with the SMO. The RIC platform is proposed to manage strict SLAs of the end-to-end 5G services by subscribing to near real-time data from the RAN, which the XApps use to infer if the RAN system is operating within desirable limits, if not applying changes to the RAN protocol stack to achieve the desirable operating point.

O-Cloud is another integral part of O-RAN architecture which hosts the physical infrastructure and virtualized RAN workloads. These are realized over COTS platform equipped with appropriate OS/Kernel, I/O, accelerators to offload certain processing required by real-time DU and CU workloads. O-Cloud forms the larger part of the paradigm shift of decoupling RAN HW and SW to allow flexible RAN deployments to meet private enterprise, (sub-) urban, rural requirements, allowing CU and DU to be placed in the hierarchical cloud deployment based on specific traffic characteristics and services being offered in that specific deployment context.

O-RAN currently focusses on near-Realtime RAN stack optimization through the RIC, this patent addresses another key missing piece which is the non-realtime and near real-time O-Cloud optimization, since if the underlying platform cannot adapt to the dynamic requirements of the RAN workloads the overall objective of preserving SLAs in non-realtime or near-realtime may fail.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the present disclosure. However, it will be apparent to those skilled in the art having the benefit of the present disclosure that the various aspects of the claims may be practiced in other examples that depart from these specific details. In certain instances, descriptions of well-known devices, circuits, and methods are omitted so as not to obscure the description of the present disclosure with unnecessary detail.

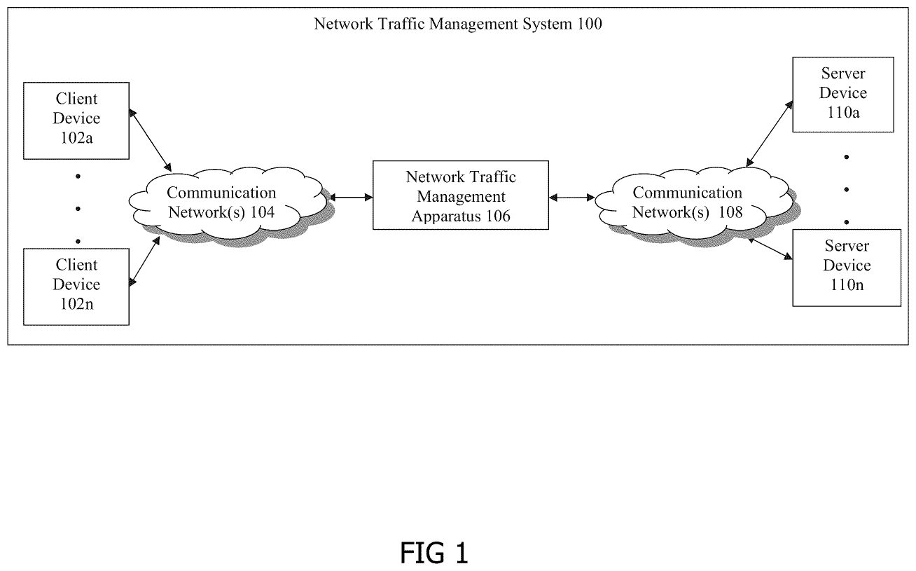

Referring to FIG. 1, an exemplary computing infrastructure to support a network-accessible client-server software application 100 can include various interconnected computing devices (e.g., network traffic device) to potentially increase scalability, availability, security, and/or performance of the client-server architecture is illustrated. As one example, an intermediary server computer, such as a network traffic management device 106 or apparatus, can be positioned logically between client devices 102a-102n seeking access to a client-server software application and the server computers 110a-110n that execute the server-side of the client-server software application. An intermediary server computer can perform various proxy and other services, such as load balancing, rate monitoring, caching, encryption/decryption, session management (including key generation), address translation, and/or access control, for example. This technology provides a number of advantages including methods, non-transitory computer readable media, network traffic management systems, and network traffic management apparatuses that provide for application deployment across a plurality of locally connected computing subdomains including smart network interface cards.

In this particular example, the network traffic management apparatus 106, server devices 110a-110n, and client devices 102a-102n are disclosed in FIG. 1 as dedicated hardware devices However, one or more of the network traffic management apparatus 106, server devices 110a-110n, and client devices 102a-102n can also be implemented in software within one or more other devices in the network traffic management system. As used herein, the term “module” refers to either an implementation as a dedicated hardware device or apparatus, or an implementation in software hosted by another hardware device or apparatus that may be hosting one or more other software components or implementations. As one example, the network traffic management apparatus 106, as well as any of its components, models, or applications, can be a module implemented as software executing on one of the server devices, and many other permutations and types of implementations can also be used in other examples. Moreover, any or all of the network traffic management apparatus 106, server devices 110a-110n, and client devices 102a-102n, can be implemented, and may be referred to herein, as a module.

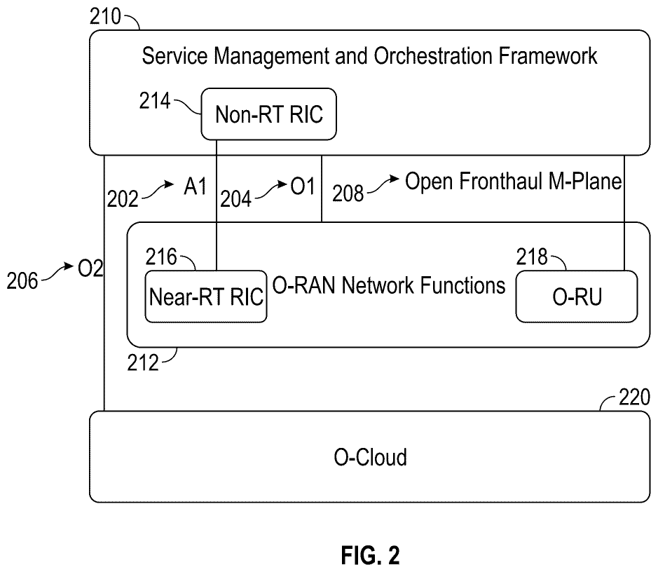

FIG. 2 depicts a conventional O-RAN architecture. The O-RAN architecture includes four O-RAN defined interfaces. A1 interface 202, O1 interface 204, O2 interface 206, and Open Fronthaul Management (M)-plane interface 208, which connects the Service Management and Orchestration Framework (SMO) framework 210 to O-RAN network functions (NFs) 212 and the O-Cloud 220 The SMO 210 can also connect with an external device or system, which can provide configuration data to the SMO 210. As further depicted, the A1 interface 202 connects the O-RAN Non-Real Time (RT) RAN Intelligent Controller (RIC) 214 in or at the SMO 210 and the O-RAN Near-RT RIC 216 in or at the O-RAN NFs 212. As will be appreciated, the O-RAN NFs 212 can be virtualized network functions such as virtual machines (VM) or containers sitting above the O-Cloud 220 and/or Physical Network Functions utilizing customized hardware. The Open Fronthaul M-plane interface 208 between the SMO 210 and the O-RAN Radio Unit (O-RU) 218 supports the O-RU management in the O-RAN hybrid model.

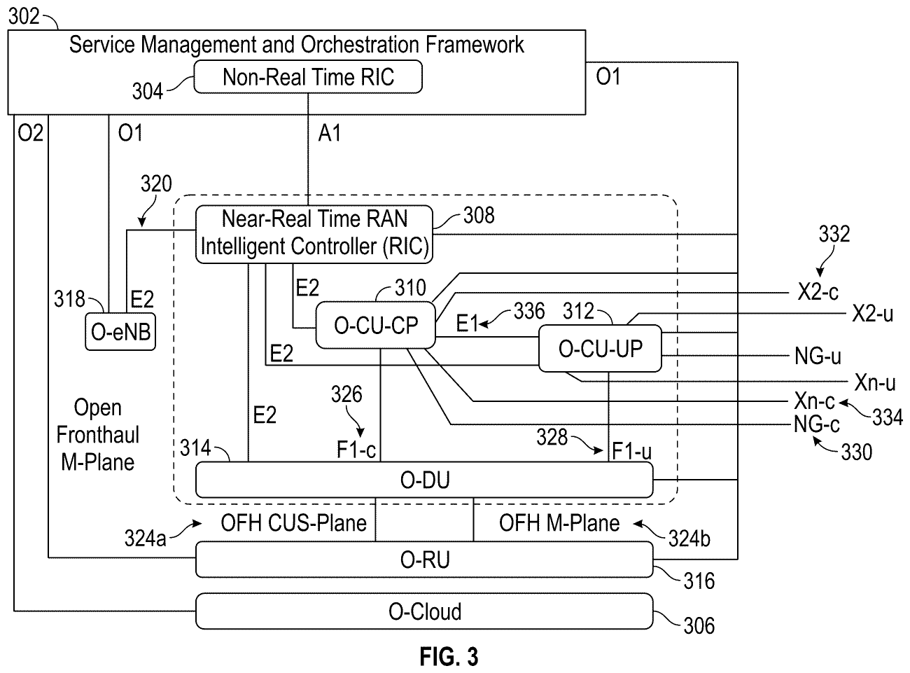

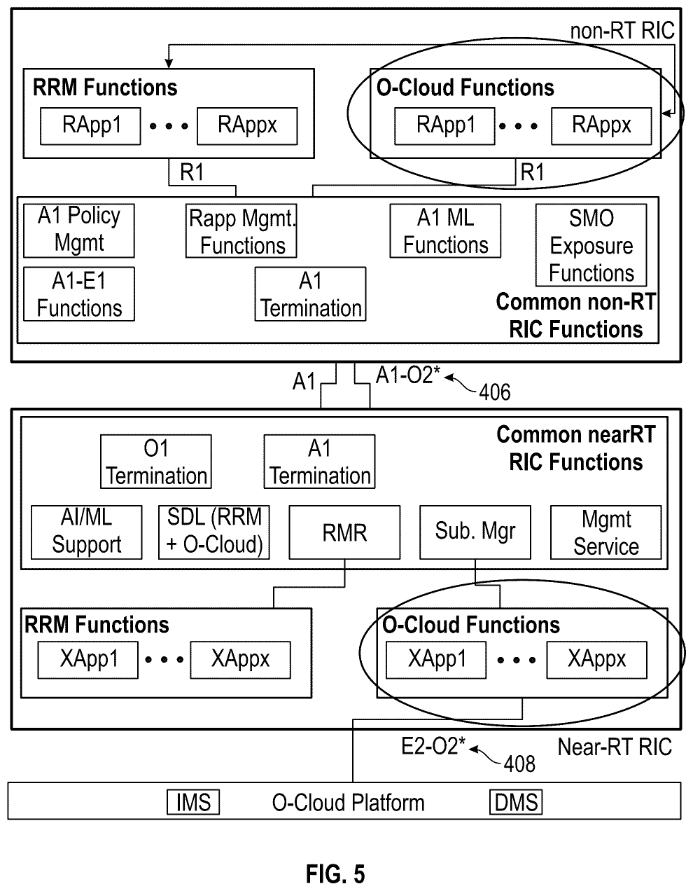

FIG. 3 shows an O-RAN logical architecture corresponding to the O-RAN architecture of FIG. 5 As will be appreciated, the O-RAN logical architecture includes a radio portion and a management portion. The management portion/side of the architectures includes the SMO Framework 302 containing the non-RT RIC 304 and management functions related to the O-Cloud instances. The O-Cloud 306 is a cloud computing platform including a collection of physical infrastructure nodes to host the relevant O-RAN functions (e.g., the near-RT RIC 308, O-RAN Central Unit-Control Plane (O-CU-CP) 310, O-RAN Central Unit-User Plane (O-CU-UP) 312, and the O-RAN Distributed Unit (O-DU) 314), supporting software components (e.g., OSs, VMMs, container runtime engines, ML engines, etc.), and appropriate management and orchestration functions. The radio portion/side of the logical architecture includes the near-RT RIC 308, the O-RAN Distributed Unit (O-DU) 314, the O-RU 316, the O-RAN Central Unit-Control Plane (O-CU-CP) 310, and the O-RAN Central Unit-User Plane (O-CU-UP) 312 functions. The radio portion/side of the logical architecture may also include the O-eNB 318.

The O-DU 314 is a logical node hosting RLC, MAC, and higher PHY layer entities/elements (High-PHY layers) based on a lower layer functional split. The O-RU 314 is a logical node hosting lower PHY layer entities/elements (Low-PHY layer) (e.g., FFT/iFFT, PRACH extraction, etc.) and RF processing elements based on a lower layer functional split. Virtualization of O-RU 316 is FFS. The O-CU-CP 310 is a logical node hosting the RRC and the control plane (CP) part of the PDCP protocol. The O O-CU-UP 312 is a logical node hosting the user-plane part of the PDCP protocol and the SDAP protocol.

An E2 interface 320 terminates at a plurality of E2 nodes. The E2 nodes are logical nodes/entities that terminate the E2 interface For NR/5G access, the E2 nodes include the O-CU-CP 310, O-CU-UP 312, O-DU 314. For E-UTRA access the E2 nodes include the O-e/gNB 318. As shown in FIG. 3, the E2 interface also connects the O-e/gNB 318 to the Near-RT RIC 304. The protocols over the E2 interface are based exclusively on Control Plane (CP) protocols The E2 functions are grouped into the following categories. (a) near-RT RIC 304 services (REPORT, INSERT, CONTROL, and POLICY); and (b) near-RT RIC 304 support functions, which include E2 Interface Management (E2 Setup, E2 Reset, Reporting of General Error Situations, etc.) and Near-RT RIC 304 Service Update (e.g., capability exchange related to the list of E2 Node functions exposed over E2).

The O-eNB 318 is an LTE eNB, a 5G gNB, or ng-eNB that supports the E2 interface. The O-eNB 318 may be the same or similar as other RAN nodes discussed previously. There may be multiple O-e/gNB 318, each of which may be connected to one another via respective interfaces

The Open Fronthaul (OF) interface(s) 324a,b is/are between O-DU 314 and O-RU 316 functions. The OF interface(s) 324a,b includes the Control User Synchronization (CUS) Plane and Management (M) Plane. FIGS. 2-3 also show that the O-RU 316 terminates the OF M-Plane 324b interface towards the O-DU 314 and optionally towards the SMO 302. The O-RU 316 terminates the OF CUS-Plane 324a interface towards the O-DU 314 and the SMO 302.

The F1-c interface 326 connects the O-CU-CP 310 with the O-DU 314. As defined by 3GPP, the F1-c 326 interface is between the gNB-CU-CP and gNB-DU nodes [O07] [O10]. However, for purposes of O-RAN, the F1-c interface is adopted between the O-CU-CP 310 with the O-DU 314 functions while reusing the principles and protocol stack defined by 3GPP and the definition of interoperability profile specifications.

The F1-u interface 328 connects the O-CU-UP 312 with the O-DU 314 As defined by 3GPP, the F1-u interface 328 is between the gNB-CU-UP and gNB-DU nodes. However, for purposes of O-RAN, the F1-u interface 328 is adopted between the O-CU-UP 312 with the O-DU functions 314 while reusing the principles and protocol stack defined by 3GPP and the definition of interoperability profile specifications.

The NG-c interface 330 is defined by 3GPP as an interface between the gNB-CU-CP and the AMF in the 5GC. The NG-c 330 is also referred to as the N2 interface. The NG-u interface is defined by 3GPP, as an interface between the gNB-CU-UP 310 and the UPF in the 5GC. The NG-u interface 330 is referred to as the N3 interface In O-RAN, NG-c and NG-u protocol stacks defined by 3GPP are reused and may be adapted for O-RAN purposes

The X2-c interface 332 is defined in 3GPP for transmitting control plane information between eNBs or between eNB and en-gNB in EN-DC. The X2-u interface is defined in 3GPP for transmitting user plane information between eNBs or between eNB and en-gNB in EN-DC. In O-RAN, X2-c and X2-u protocol stacks defined by 3GPP are reused and may be adapted for O-RAN purposes

The Xn-c interface 334 is defined in 3GPP for transmitting control plane information between gNBs, ng-eNBs, or between an ng-eNB and gNB. The Xn-u interface is defined in 3GPP for transmitting user plane information between gNBs, ng-eNBs, or between ng-eNB and gNB In O-RAN, Xn-c and Xn-u protocol stacks defined by 3GPP are reused and may be adapted for O-RAN purposes.

The E1 interface 331 is defined by 3GPP as being an interface between the gNB-CU-CP and gNB-CU-UP. In O-RAN, E1 protocol stacks defined by 3GPP are reused and adapted as being an interface between the O-CU-CP 310 and the O-CU-UP 312 functions.

The O-RAN Non-Real Time (RT) RAN Intelligent Controller (RIC) is a logical function within the SMO framework that enables non-real-time control and optimization of RAN elements and resources; AI/machine learning (ML) workflow(s) including model training, inferences, and updates; and policy-based guidance of applications/features in the Near-RT RIC

In some embodiments, the Non-RT RIC is a function that sits within the SMO platform (or SMO framework) in the O-RAN architecture. The primary goal of non-RT RIC is to support intelligent radio resource management for a non-real-time interval (i.e., greater than 500 ms), policy optimization in RAN, and insertion of AI/ML models to near-RT RIC and other RAN functions The non-RT RIC terminates the A1 interface to the near-RT RIC It will also collect OAM data over the O1 interface from the O-RAN nodes

The O-RAN near-RT RIC is a logical function that enables near-real-time control and optimization of RAN elements and resources via fine-grained data collection and actions over the E2 interface The near-RT RIC may include one or more AI/ML workflows including model training, inferences, and updates.

The non-RT RIC can be an ML training host to host the training of one or more ML models. ML training can be performed offline using data collected from the RIC, O-DU, and O-RU. For supervised learning, non-RT RIC is part of the SMO, and the ML training host and/or ML model host/actor can be part of the non-RT RIC and/or the near-RT RIC. For unsupervised learning, the ML training host and ML model host/actor can be part of the non-RT RIC and/or the near-RT RIC. For reinforcement learning, the ML training host and ML model host/actor may be co-located as part of the non-RT RIC and/or the near-RT RIC. In some implementations, the non-RT RIC may request or trigger ML model training in the training hosts regardless of where the model is deployed and executed ML models may be trained and not currently deployed.

In some implementations, the non-RT RIC provides a query-able catalog for an ML designer/developer to publish/install trained ML models (e.g., executable software components). In these implementations, the non-RT RIC may provide a discovery mechanism if a particular ML model can be executed in a target ML inference host (MF), and what number and type of ML models can be executed in the MF For example, there may be three types of ML catalogs made discoverable by the non-RT RIC: a design-time catalog (e.g., residing outside the non-RT RIC and hosted by some other ML platform(s)), a training/deployment-time catalog (e.g., residing inside the non-RT RIC), and a run-time catalog (e.g., residing inside the non-RT RIC) The non-RT RIC supports necessary capabilities for ML model inference in support of ML assisted solutions running in the non-RT RIC or some other ML inference host. These capabilities enable executable software to be installed such as VMs, containers, etc. The non-RT RIC may also include and/or operate one or more ML engines, which are packaged software executable libraries that provide methods, routines, data types, etc., used to run ML models. The non-RT RIC may also implement policies to switch and activate ML model instances under different operating conditions.

The non-RT RIC can access feedback data (e g., FM and PM statistics) over the O1 interface on ML model performance and perform necessary evaluations. If the ML model fails during runtime, an alarm can be generated as feedback to the non-RT RIC. How well the ML model is performing in terms of prediction accuracy or other operating statistics it produces can also be sent to the non-RT RIC over O1. The non-RT RIC can also scale ML model instances running in a target MF over the O1 interface by observing resource utilization in MF. The environment where the ML model instance is running (e.g., the MF) monitors resource utilization of the running ML model. This can be done, for example, using an ORAN-SC component called ResourceMonitor in the near-RT RIC and/or in the non-RT RIC, which continuously monitors resource utilization. If resources are low or fall below a certain threshold, the runtime environment in the near-RT RIC and/or the non-RT RIC provides a scaling mechanism to add more ML instances. The scaling mechanism may include a scaling factor such as a number, percentage, and/or other like data used to scale up/down the number of ML instances. ML model instances running in the target ML inference hosts may be automatically scaled by observing resource utilization in the MF For example, the Kubernetes® (K8s) runtime environment typically provides an auto-scaling feature.

The A1 interface is between the non-RT RIC (within or outside the SMO) and the near-RT RIC. The A1 interface supports three types of services, including a Policy Management Service, an Enrichment Information Service, and ML Model Management Service. A1 policies have the following characteristics compared to persistent configuration: A1 policies are not critical to traffic; A1 policies have temporary validity; A1 policies may handle individual UE or dynamically defined groups of UEs; A1 policies act within and take precedence over the configuration; and A1 policies are non-persistent, i.e., do not survive a restart of the near-RT RIC.

As illustrated in FIG. 2 and FIG. 3, the following O-RAN interfaces may be configured.
(a) A1 interface is between Non-RT-RIC and the Near-RT RIC functions; A1 is associated with policy guidance for control-plane and user-plane functions; Impacted O-RAN elements associated with A1 include O-RAN nodes;
(b) O1 interface is between O-RAN Managed Element and the management entity; O1 is associated with Management-plane functions, Configuration, and threshold settings mostly OAM & FCAPS functionality to O-RAN network functions; Impacted O-RAN elements associated with O1 include mostly O-RAN nodes;
(c) O2 interface is between the SMO and Infrastructure Management Framework; O2 is associated with Management of Cloud infrastructure and Cloud resources allocated to O-RAN, FCAPS for O-Cloud; Impacted O-RAN elements associated with O2 include O-Cloud;
(d) E2 interface is between Near-RT RIC and E2 node; E2 is associated with control-plane and user-plane control functions; Impacted O-RAN elements associated with E2 include E2 nodes, E2-cp is between Near-RT RIC and O-CU-CP functions. E2-up is between Near-RT RIC and O-CU-UP functions: E2-du is between Near-RT RIC and O-DU functions. E2-en is between Near-RT RIC and O-eNB functions; and
(g) Open Fronthaul Interface is between 0-DU and O-RU functions; this interface is associated with CUS (Control User Synchronization) Plane and Management Plane functions and FCAPS to O-RU; Impacted O-RAN elements associated with the Open Fronthaul Interface include O-DU and O-RU functions.

O-Cloud is a critical piece of the distributed infrastructure hosting the RAN functions, which include CU-UP, CU-CP. DU and the RIC. During operation, O-Cloud is expected to generate significant amount of health and performance related data at the Physical Level, Virtual Level and the Workload Level. Physical level data relates to physical devices— NICs, Processors, OS, Accelerators, Switches or Storage nodes, this includes power or energy metrics, operational status, physical parameters like temperature or fan speed etc. Data could be workload or non-workload related metrics such as operational state, total utilization, temperature etc. Virtual level (Cluster level) data relates to health of functions managing the virtualization functions such as CRI, Kubelet, Workloads, CNI Plugins and device drivers, and also performance metrics such as aggregate utilization of each virtualized resources such as Accelerators, CPUs, Memory etc, or the power/energy consumption by each of these virtual resources dedicated to a Workload. Workload related data relates to available and utilized VF resources pertaining to a specific workload This critical data can be used to drive AI/ML functions hosted in the near-RT or the non-RT RIC to predict any anomalies with the o-cloud infrastructure (planned or reactive), or serve energy optimization objectives and take remedial actions such as seamless workload migration to another host avoiding any service disruption.

Current approaches to address near-realtime O-Cloud optimization rely predominantly on using non-RAN agnostic functions realized either as part of the site or cluster scoped O-Cloud virtualization platform software (e.g., K8S Controllers) or through long timescale optimization intelligence in the SMO and leveraging O2-ims and O2-dms interface between the centralized SMO and the distributed O-Cloud instances. As will be appreciated, the O-cloud distributed sites could be in order of thousands, hence invoking scalability concerns too. These solutions, as of now, are not adept to react to near-RT optimization requirements.

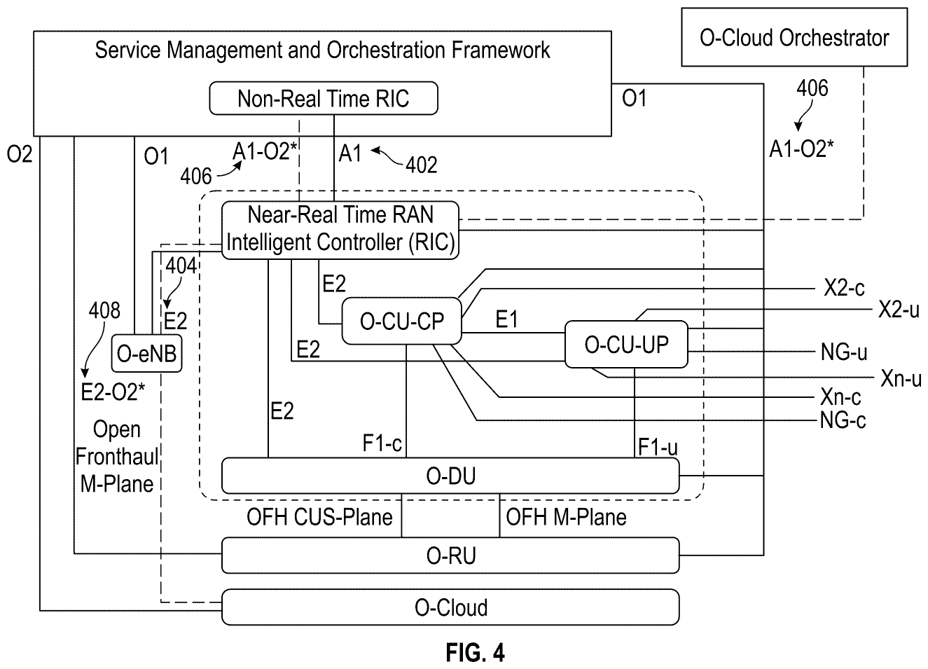

FIGS. 4-9 depict various embodiments of the presently disclosed technology. As shown and described further below, the disclosed technology is directed to address near-realtime O-Cloud optimization requirements impacting CU/DU performance because of dynamic changes to the workload, fault performance, or timing/synchronization degradation of the O-Cloud platform. These dynamic changes require dynamic adaptation of the underlying O-Cloud resources such as compute, memory, accelerator or I/O resources to meet DU's or CU's near-realtime requirements. Further, the systems may require near-realtime notification services exposure from the underlying physical and virtualized platform to the RAN workload to allow for corrective actions.

Examples of the present technology require optimization functions to be operating in near-RT scale similar to RRM XApps in order to meet the near-RT requirements from a O-Cloud programmability perspective This requires functions similar to RAN (i.e. O-Cloud centric XApps) to be operating as part of the near-RT RIC and non-RT RIC platforms, so that the O-Cloud/R-Apps can set the policies in the distributed O-Cloud/X-Apps and O-Cloud X-Apps can subscribe to the relevant data from the O-Cloud's IMS and DMS sub-systems and execute control functions to meet the policy requirements. As depicted in FIGS. 3-9, examples of the described technology extend the near-RT and the non-RT RIC to host virtualized resource, healing, infrastructure troubleshooting, energy savings, and optimization functions related to the O-Cloud. Further, the proposed solutions can predict or react to any anomalies with the hardware, virtualization, or the workloads and take remedial action to mitigate any disruption to the RAN services. In addition, the RRM/XApps can also communicate with the O-Cloud platform to subscribe to data related to physical, virtual or the workload specific functions, and request any additional resources to meet future expected demand for the specific set of DUs or CUs.

FIG. 4 depicts an O-RAN logical architecture having updates to the A1 402 and E2 404 interfaces. As depicted, the architecture includes extensions to current A1 402 and E2 404 interfaces. As described further below, the extensions allow life cycle management of O-Cloud Xapps, Policy management of the Xapps and data subscription/control of the O-Cloud instance using the IMS and DMS function. Specifically. the A1-O2*extension 406 allows for setting policies in the O-Cloud related XApps operating to optimize the physical and the virtual workloads resources. The E2-O2*extension 408 extends the semantics and the APIs proposed for the CU and DU, and acts on the near-RT data from the O-Cloud and takes actions to achieve specific policy objectives. As will be appreciated, this allows a standardized approach for third party O-Cloud XApps to request and apply control either at the physical hardware tuning and optimization or in the virtualization layers.

The O-Cloud XApps may be standalone service(s) serving the purpose of managing the O-cloud resources in the cluster or could compliment the RAN/X-Apps to maintain the policy objectives of RAN services and functions. For example, the RAN/X-Apps can be used to scale-out or scale-in resources vertically or horizontally The purpose of such O-Cloud X-Apps would be similar to RRMs, which is to monitor and control and adapt the behavior of the O-Cloud instance with the changing needs of the RAN workloads. For example, a traffic steering X-App/R-App, while monitoring the utilization of Cell(s) associated with a DU, can interface with a O-Cloud X-App/R-App to scale resources reacting to dynamics of user traffic in a cell, resources include CPU cores, Hugepages, V/O, accelerator resources, etc or create new instances of the network function. As another example, a standalone o-Cloud X-App/R-App monitoring the Host or Virtualized resources could initiate migration of workloads if it notices any anomalies with respect to either host or virtualized resource related health or performance metrics. In another example, an O-Cloud Xapp could be used to monitor the time synchronization for each host hosting DU functions. Any detected lack of synchronization could invoke steps such as check PTP connectivity to the PTRC/GM or the boundary clock switch.

As will be appreciated, the architecture depicted in FIG. 4 could allow for automated lifecycle management (LCM) of the O-Cloud Xapps to be completed using the O1/O2 interfaces. Further, the SMO/Non-RT RIC interface functions can be extended to train the Al/ML models using the data from O2. These ML models can then be managed by the non-RT RIC over A1-O2 for near-RT optimization objectives.

FIG. 5 depicts a more detailed system architecture diagram incorporating the newly added interfaces described above with respect to FIG. 4. As depicted in FIG. 5, the disclosed technology includes a new set of O-Cloud RApps in the non-RT RIC, labeled as O-Cloud/RApps. These applications are use case specific just like RRM functions For example, an RApp may be designed so as to set resource objectives for the distributed O-Cloud/XApps, focused on optimization aspects of the O-Cloud infrastructure and network functions, which include resource, healing, infrastructure troubleshooting, energy savings optimization functions. As further depicted, the disclosed technology also includes a set of applications that are located in the near-RT RIC instances labeled as O-Cloud/XApps. As depicted, the O-Cloud/XApps receive the policy objectives from the RApps and interface with the local IMS/DMS functions for near-RT data and programmatically react to set the configuration parameters to meet O-Cloud service objectives. Additionally, the O-Cloud/RApps can be configured to interface with the RRM/RApps in the non-RT platform and the O-Cloud/XApps can be configured to interface with RRM/XApps in the nearRT platform through APIs to affect changes to the O-Cloud resources associated with the RAN workloads or to subscribe to data required for RAN workload reliable functioning.

As will be appreciated, the O-Cloud/RApps and O-Cloud/XApps functions can leverage the non-RT RIC and near-RT platforms for data access, inter-XApps communication and leverage the protocol termination function such as O2/A1/E2 to meet its own objectives. In addition to RRM data, the database can also be configured to manage data from O-Cloud physical, virtual or workload functions.

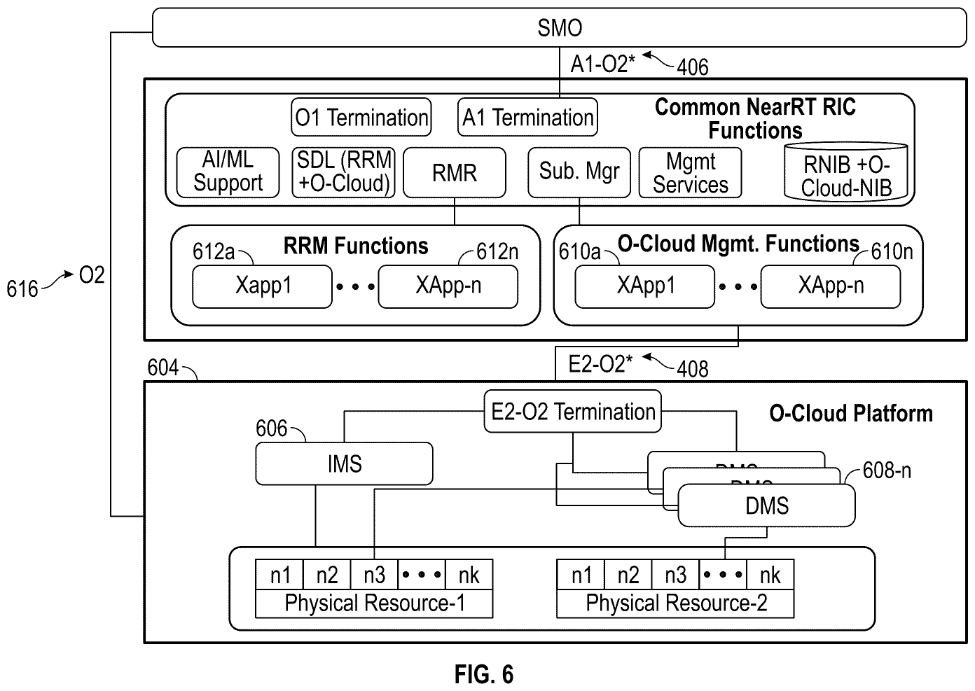

FIG. 6 depicts a more detailed system architecture diagram incorporating the newly added interfaces described above with respect to FIG. 4 In an example of the present disclosure, the A1 interface is expanded to identify a new set of APIs to set policies specific to O-Cloud Xapps 610. For example, as depicted in FIG. 6, the A1-O2*interface 406 can allow interaction between O-Cloud/RApps 612 and O-Cloud/Xapps 610. As will be appreciated, the O-Cloud/XApp 610 exposes APIs to set localized O-Cloud centric intent targeted for a specific set of RAN workloads (DUs and CUs). These intents or declarative rules can include threshold limits on parameters related to Energy utilization or policies, CPU, Memory, I/O or Accelarator usage, Timing/Sync tolerable error. As will be appreciated, the APIs are application specific. Accordingly, depending on the o-Cloud optimization objective, they can include all or subset of the previous mentioned policy objectives of physical infrastructure, cluster services, virtual management system or specific RAN workload. These APIs are consumed by the O-Cloud/RApps to set policy objectives in the O-Cloud/Xapps. Policy feedback (success or failure or any intermediate state) over A1-O2*406 can be correlated with PM data over O2 616 to measure the success of a policy. The A1-O2*406 can also be provided with enrichment information for o-Cloud/X-Apps 610-external source outside what is available from the o-Cloud IMS/DMS sources.

Further, the A1/O2* interface 406 can also be used for ML model management executing as part of the O-Cloud/XApps. The data from the O-Cloud instances can be used by SMO and non-RT. For example, the RRM/Rapps functions could coordinate with the corresponding O-Cloud/Rapps for intent policy management, conformance or finalization.

As further depicted in FIG. 6, the E2-O2* interface 408 can be configured to terminate in the O-Cloud 604 instead of the RAN functions (CU/DU). The IMS 606 and DMS 608 systems expose service models that identifies PM/FM or Control APIs that are exposed by the Physical Infrastructure, Cluster and Network function Management layer both for the virtualized resources and the managed workload. These service models allow O-Cloud/XApps 610 to subscribe to specific metrics, set triggers for notification if certain thresholds are violated, set policies to take certain actions or wait for the O-Cloud/Xapps 610 to trigger action if certain conditions are violated. The previously described additional APIs also apply to the newly described E2-O2* interface 408. For example, the new E2-SM interface can be realized to handle use cases specific to O-Cloud functions. Specific E2SM APIs (e.g., specific to data, policy, control, etc.) can be configured based on specific use cases. As depicted, the RRM Xapps 612 can interface with associated O-Cloud Xapps 610 for coordination of O-Cloud resource management functions, performance management (data subscription), alert/failure notifications, and other related functions.

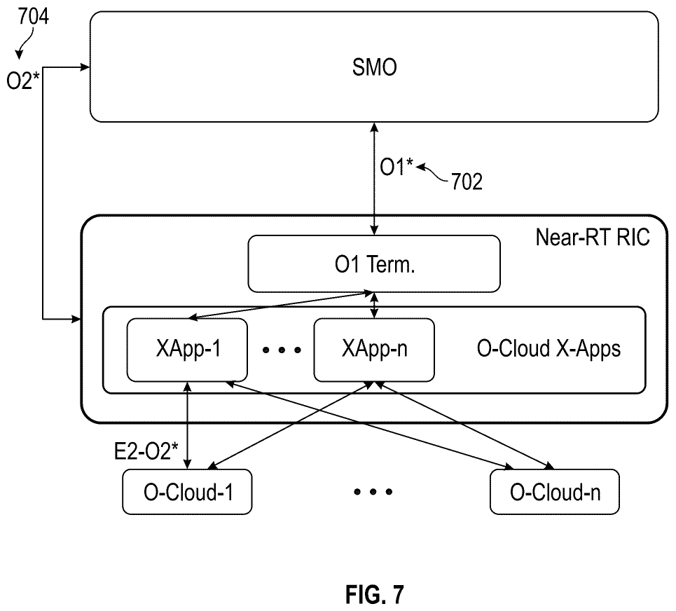

FIG. 7 depicts a subset of an O-RAN logical architecture having updates to the O1 and O2 interfaces As depicted, the O1* interface 702 has been updated to manage configuration and data subscription of the O-Cloud Xapps and the O2* interface 704 has been updated to manage LCM of O-Cloud XApps. For example, the O1* interface 702 can manage the configuration and data subscription of the O-Cloud/XApps and its service-centric life cycle management and the O2* interface 704 can manage the on-boarding, deployment, activation, life cycle, and resource management for the O-Cloud/XApps, considering these XApps will also include ML inferencing O-Cloud models that may require GPU resources. As will be appreciated, such a configuration allows the O2/O1 interface to the O-Cloud Xapps could offer similar functions as that of RRM Xapps. As previously described, such an improvement will ensure high availability of RAN service(s)

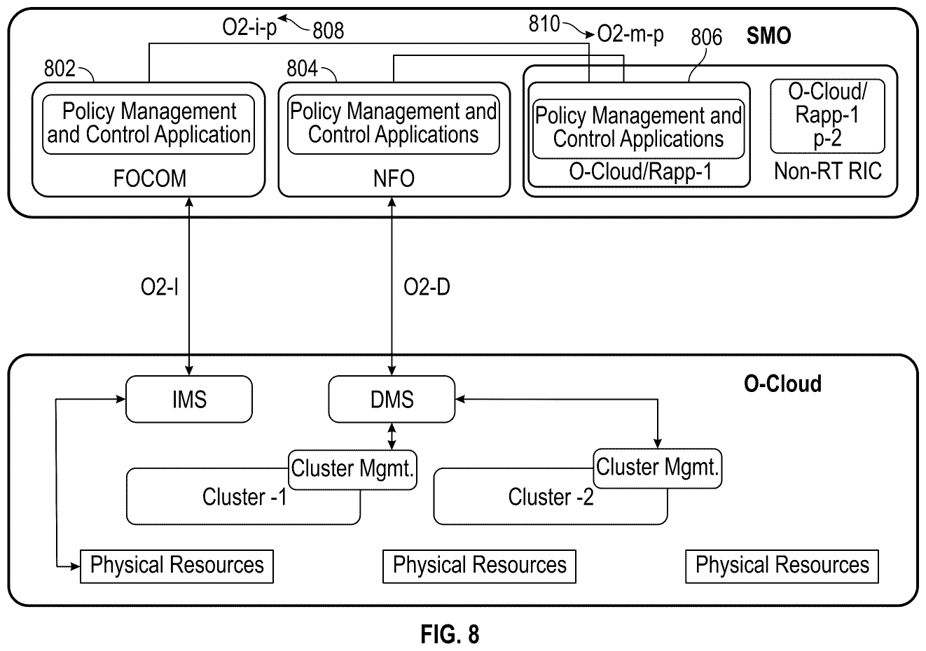

FIG. 8 depicts a subset of an O-RAN logical architecture having updates to the O1 and O2 interfaces. As will be appreciated, FOCOM 802 is part of SMO that manages O-Clouds physical and virtual infrastructure and NFO 804 is part of SMO to manage the life cycle of NF deployments. In the disclosed technology, the O-Cloud/RApps 806 can subscribe to data from the FOCOM 802 and NFO 804 and apply policies and control actions over the 02 interface through the FOCOM 802 and NFO 804. FOCOM 802 in SMO manages the LCM of the O-Cloud infrastructure and the cluster instances, while the NFO 804 manages the LCM of the virtual Network Functions (VNF) or containerized network functions (CNF).

As an example, the O-Cloud/RApp 806 manages policy and includes logic to enforce it too. In this case, depending on the O-Cloud Application's policy requirement, the Rapps 806 will subscribe to the relevant data through FOCOM 802 and NFO 804 over the O2-i-p/o2-i-m 808/810 interface, and executes control actions in case of violation over them. These actions are notified to the FOCOM 802 and the NFO 804 depending on if they are actions to the physical infrastructure or related to the NF management actions. The Control Application in the FOCOM 802 and the NFO 804 in this case, maps these actions over the O2 interface.

As a further example, The FOCOM 802 and NFO 804 could include logic to manage the policies and invoke control actions too. In this scenario, the policy management application in O-Cloud/Rapps 806 will communicate the policy requirements to the FOCOM 802 and NFO 804 over the O2-i-p/o2-i-m interface 808/810. The Control Application in the FOCOM 802 and NFO 804 would subscribe the relevant data from the O-Cloud and invoke control actions over the O2 interface if any of the policies are violated. The Policy management in FOCOM 802/NFO 804 can then notify the O-Cloud/Rapp 806 about the status (success or failure) of the requested policies.

The disclosed technology can be used to address a variety of use case scenarios. For example, a typical use case may be in a flash crowd scenario noticed in stadiums, airports, malls, or dense urban settings. During flash crowd scenarios a particular geographic location will experience a large uptick in network traffic resulting in congestion in a set of adjacent RAN cell sites managed by the same DU. Further, it is common that the related CU which will eventually notice a traffic surge as well. In traditional systems, the RAN XApps would react to this would be through traffic steering, which involves balancing the traffic load between cells. As will be appreciated, this may not work in this scenario as the adjacent cells are also highly loaded

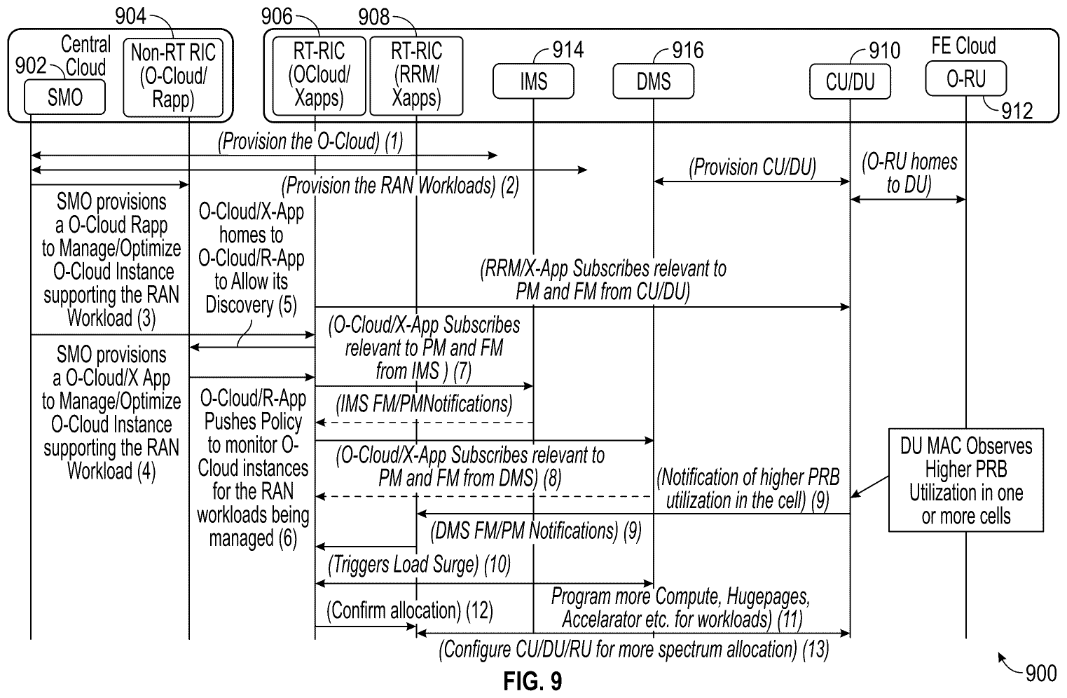

The disclosed technology could be used to instantiate a O-Cloud/X-Apps apriori with necessary policy objectives to monitor the DU and CU resource requirements, and have the O-Cloud/X-App request increase in compute, memory or accelerator resources to the DMS system to offer more resources to the DU and CU handling the additional load, or reduce the compute, memory or accelerator resources to conserve energy at each O-Cloud site This request can be triggered through APIs exposed by the O-Cloud/X-Apps to request scale-in/out of resources to the RRM/XApps that can be invoked in near-RT timescales. FIG. 9 depicts data flow diagram 900 for such an example case. As depicted, the transactions shown in red represent interactions enabled by the described technology. As will be appreciated, while the general flow will be the same for most of the use case scenarios, the particulars of the policy set in the O-Cloud/RApps and O-Cloud/XApps, data subscription and control invocation APIs will differ.

As depicted, in step (1), the SMO 902 uses the O2-ims interface to provision an O-Cloud instance on which the RAN workloads will be hosted. In step (2), the SMO 902 provisions the RAN workloads i.e. DU. CU-UP 910 and CU-CP. In step (3), the SMO 902 provisions the O-Cloud/Rapp 904 and RRM/RApp for control and management of the RAN workloads. In step (4), the SMO 902 also provisions the O-Cloud/XApp 904 and the RRM/Xapp 908 for near-RT optimization and control of services hosted in the RAN Workloads. In step (5), the O-Cloud/Xapp 906 registers with the O-Cloud/Rapps 904 enabling its discovery in the FE or the Edge.

As further depicted, in step (6), the O-Cloud/RApp 904 sets the policy in the O-Cloud/XApp 906 to monitor the O-Cloud resources dedicated for the RAN workloads. In this scenario, it must identify the O-Cloud-IDs and for each O-Cloud instance the set of DU and CU-UP 910 instances uniquely within in the context of the DMS instance. For each virtualized workload, the O-Cloud/RApps 904 set thresholds for parameters relevant to the RAN workload such as Power/Energy, Compute, Memory, 110 or Accelerator resources. The thresholds could be statistical metrics such as average. max/min, variance of the specific PM it measures for the specific workload or for the host itself from an aggregate perspective. Further, in steps (7) and (8), based on the policy requirements, the O-Cloud/Xapp 906 subscribes to the PM/TM metrics through the IMS/DMS 914, 916 function managing the O-Cloud and the RAN workloads. Also, we assume the RRM/XApp 908 has been policy configured and subscribes to the PM/FM data from the RAN workloads

In step (9), there is a notification from the DU/CU 910 with metrics suggesting this situation to the RRM/Xapp 908. As will be appreciated, such a notification would occur during an ongoing Flash Crowd scenario in the cells being served by the set of DUs or CUs under the O-Cloud instances being managed by the O-Cloud/Xapp 906 In step (10), the RRM/XApp 908 and the O-Cloud/Xapp 906 being under the same near-RT instance uses the APIs exposed by the O-Cloud/XApp 906 to increase the underlying O-Cloud resources to these RAN workloads. In step (11), the O-Cloud/XApp 906 then invokes the appropriate control APIs of the DMS to increase the Compute, Memory, I/O or Accelerator resources for those RAN workload managing the set of cells observing the flash crowd. In step (12), the O-Cloud/XApp 906 acknowledges the successful completion of the request to the RRM/Xapp 908. Finally, in step (13), the RRM/Xapp 908 then configures the CU/DU/RU 910, 912 to operate with more spectral resources, exploiting the additional O-Cloud resources now at the disposal of the vRAN workloads to utilize

Each of the server devices of the network traffic management system in this example includes processor(s), a memory, and a communication interface, which are coupled together by a bus or other communication link, although other numbers or types of components could be used. The server devices in this example can include application servers, database servers, access control servers, or encryption servers, for example, that exchange communications along communication paths expected based on application logic in order to facilitate interactions with an application by users of the client devices

Although the server devices are illustrated as single devices, one or more actions of each of the server devices may be distributed across one or more distinct network computing devices that together comprise one or more of the server devices. Moreover, the server devices are not limited to a particular configuration. Thus, the server devices may contain network computing devices that operate using a master/slave approach, whereby one of the network computing devices of the server devices operate to manage or otherwise coordinate operations of the other network computing devices. The server devices may operate as a plurality of network computing devices within a cluster architecture, a peer-to peer architecture, virtual machines, or within a cloud architecture, for example.

Thus, the technology disclosed herein is not to be construed as being limited to a single environment and other configurations and architectures are also envisaged For example, one or more of the server devices can operate within the network traffic management apparatus itself rather than as a stand-alone server device communicating with the network traffic management apparatus via communication network(s). In this example, the one or more of the server devices operate within the memory of the network traffic management apparatus.

The client devices of the network traffic management system in this example include any type of computing device that can exchange network data, such as mobile, desktop, laptop, or tablet computing devices, virtual machines (including cloud-based computers), or the like. Each of the client devices in this example includes a processor, a memory, and a communication interface, which are coupled together by a bus or other communication link (not illustrated), although other numbers or types of components could also be used.

The client devices may run interface applications, such as standard web browsers or standalone client applications, which may provide an interface to make requests for, and receive content stored on, one or more of the server devices via the communication network(s). The client devices may further include a display device, such as a display screen or touchscreen, or an input device, such as a keyboard for example (not illustrated). Additionally, one or more of the client devices can be configured to execute software code (e.g., JavaScript code within a web browser) in order to log client-side data and provide the logged data to the network traffic management apparatus, as described and illustrated in more detail later.

Although the exemplary network traffic management system with the network traffic management apparatus, server devices, client devices, and communication network(s) are described and illustrated herein, other types or numbers of systems, devices, components, or elements in other topologies can be used It is to be understood that the systems of the examples described herein are for exemplary purposes, as many variations of the specific hardware and software used to implement the examples are possible, as will be appreciated by those skilled in the relevant art(s).

One or more of the components depicted in the network security system, such as the network traffic management apparatus, server devices, or client devices, for example, may be configured to operate as virtual instances on the same physical machine In other words, one or more of the network traffic management apparatus, server devices, or client devices may operate on the same physical device rather than as separate devices communicating through communication network(s). Additionally, there may be more or fewer network traffic management apparatuses, client devices, or server devices than illustrated in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only, wireless traffic networks, cellular traffic networks. Packet Data Networks (PDNs), the Internet, intranets, and combinations thereof

The examples may also be embodied as one or more non-transitory computer readable media having instructions stored thereon, such as in the memory, for one or more aspects of the present technology, as described and illustrated by way of the examples herein. The instructions in some examples include executable code that, when executed by one or more processors, such as the processor(s), cause the processors to carry out steps necessary to implement the methods of the examples of this technology that are described and illustrated herein.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers. letters, or other designations therefore, is not intended to limit the claimed processes to any order except as may be specified in the claims. Accordingly, the invention is limited only by the following claims and equivalents thereto.

What is claimed is:

1. A method for O-RAN optimization implemented in cooperation with a network system comprising one or more network infrastructure devices, server devices, or client devices, the method comprising:
receiving, via an interface between the O-Cloud orchestrator and the near-realtime RAN intelligent controller (“near-RT RIC”), policies related to O-Cloud workload optimization;
determining one or more policy scenarios have occurred;
subscribing, via one or more XApps on the near-RT RIC, to data associated with the policies related to O-Cloud workload optimization;
transmitting, from the near-RT RIC to the O-Cloud, instructions for one or more corrective actions;
executing, via a control application on the O-Cloud, one or more corrective actions consistent with the received instructions; and
transmitting, from the one or more Xapps on the O-Cloud, confirmation of the execution of the one or more corrective actions.

2. The method of claim 1, wherein the Xapps on the near-RT RIC are configured to receive data from the O-Cloud and from external sources.

3. The method of claim 1, wherein an Xapp of the one or more XApps is configured monitoring the utilization of cells associated with a DU and interface with other O-Cloud resources to dynamically scale resources in response to detected traffic.

4. The method of claim 1, wherein the one or more XApps comprises a plurality of XApps operatively linked to perform coordinated operations.

5. The method of claim 4, wherein the one or more XApps are configured to interface with the IMS and DMS of the O-Cloud to perform resource management functions.

6. A near-realtime RAN intelligent controller (“near-RT RIC”) device configured to be used in an open radio access network (“ORAN”), comprising memory comprising programmed instructions stored thereon and one or more processors configured to be capable of executing the stored programmed instructions to:
receive, via an interface between the non-real time RAN intelligent controller (“non-RT RIC”) in the O-Cloud orchestrator and the near-RT RIC, policies related to O-Cloud workload optimization;
determine, one or more policy scenarios have occurred;
subscribe, via one or more XApps on the near-RT RIC, to data associated with the policies related to O-Cloud workload optimization;
transmit, from the near-RT RIC to the O-Cloud, instructions for one or more corrective actions;
receive, from the one or more Xapps on the O-Cloud, confirmation of the execution of the one or more corrective actions; and
analyze data received from the O-cloud to verify that corrective action has occurred.

7. The near-RT RIC device of claim 6, wherein the Xapps on the O-Cloud are configured to receive data from the O-Cloud and from external sources.

8. The near-RT RIC device of claim 6, wherein an Xapp of the one or more XApps is configured monitoring the utilization of cells associated with a DU and interface with other O-Cloud resources to dynamically scale resources in response to detected traffic.

9. The near-RT RIC device of claim 6, wherein the one or more XApps comprises a plurality of XApps operatively linked to perform coordinated operations.

10. The near-RT RIC device of claim 9, wherein the one or more XApps are configured to interface with the IMS and DMS of the O-Cloud to perform resource management functions.

11. A non-transitory computer readable medium having stored thereon instructions for comprising executable code that, when executed by one or more processors, causes the processors to:
receive, via an interface between the O-Cloud orchestrator and the near-realtime RAN intelligent controller (“near-RT RIC”), policies related to O-Cloud workload optimization;
determine one or more policy scenarios have occurred;
subscribe, via one or more XApps on the near-RT RIC, to data associated with the policies related to O-Cloud workload optimization;
transmit, from the near-RT RIC to the O-Cloud, instructions for one or more corrective actions;
execute, via a control application on the O-Cloud, one or more corrective actions consistent with the received instructions; and
transmit, from the one or more Xapps on the O-Cloud, confirmation of the execution of the one or more corrective actions.

12. The non-transitory computer readable medium of claim 11, wherein the Xapps on the O-Cloud are configured to receive data from the O-Cloud and from external sources.

13. The non-transitory computer readable medium of claim 12, wherein an Xapp of the one or more XApps is configured monitoring the utilization of cells associated with a DU and interface with other O-Cloud resources to dynamically scale resources in response to detected traffic.

14. The non-transitory computer readable medium of claim 11, wherein the one or more XApps comprises a plurality of XApps operatively linked to perform coordinated operations.

15. The non-transitory computer readable medium of claim 14, wherein the one or more XApps are configured to interface with the IMS and DMS of the O-Cloud to perform resource management functions.

16. A radio access network system, comprising one or more network management apparatuses, server devices, or client devices, memory comprising programmed instructions stored thereon, and one or more processors configured to be capable of executing the stored programmed instructions to:
receive, via an interface between the O-Cloud orchestrator and the near-realtime RAN intelligent controller, policies related to O-Cloud workload optimization;
determine, one or more policy scenarios have occurred;
transmit, from the near-realtime RAN intelligent controller to the O-Cloud, instructions for one or more corrective actions;
execute, via one or more XApps on the O-Cloud, one or more corrective actions consistent with the received instructions; and
transmit, from the one or more Xapps on the O-Cloud, confirmation of the execution of the one or more corrective actions. generate a bridge between the plurality of hypervisors of the locally connected computing subdomains;

17. The radio access network system of claim 16, wherein the Xapps on the O-Cloud are configured to receive data from the O-Cloud and from external sources.

18. The radio access network system of claim 16, wherein an Xapp of the one or more XApps is configured monitoring the utilization of cells associated with a DU and interface with other O-Cloud resources to dynamically scale resources in response to detected traffic.

19. The radio access network system of claim 16, wherein the one or more XApps comprises a plurality of XApps operatively linked to perform coordinated operations.

20. The radio access network system of claim 16, wherein the one or more XApps are configured to interface with the IMS and DMS of the O-Cloud to perform resource management functions.
